(19) United States
(12) Patent Application Publication
(10) Pub. No.: US 2005/0267901 A1
(43) Pub. Date: Dec. 1, 2005

(54) Distributed single schema data modeling system and method

(76) Inventor: Kevin Irlen, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/097,754

(22) Filed: Mar. 31, 2005

Related U.S. Application Data
(63) Continuation-in-part of application No. 09/710,499, filed on Nov. 10, 2000.
(60) Provisional application No. 60/558,048, filed on Mar. 31, 2004.

(51) Int. Cl. G06F 7/00

(52) U.S. Cl. 707/100

(57) ABSTRACT

Systems and methods are provided that allow for distributed implementation of a data model that allows information needed by any system to be computerized in a generic manner. The system employs a temporal data model that is universal across individual instantiation of the data model for a particular dataset. The data model is configured to allow for simple combination of disparate datasets into a single database without complex merge operations. Accordingly, the systems and methods provided allow information system designers to avoid commingling the specific requirements of a particular dataset with the underlying data model. Also provided are systems and methods that allow information to be maintained without the need for the direct use of a relational database to encode information.

### RELATED APPLICATION

The present application claims priority to U.S. provisional patent application Ser. No. 60/558,048 filed on Mar. 31, 2004 and is a continuation-in-part of U.S. patent application Ser. No. 09/710,499 filed on Nov. 10, 2000, each of which is incorporated herein by reference in its entirety.

### COMPUTER PROGRAM LISTING APPENDIX

The present application includes a computer program listing appendix submitted on a single compact disc including an example XML Schema and an example SQL Schema, each of which is incorporated herein by reference in its entirety.

### BACKGROUND

1. Field of the Invention

The present invention generally relates to open ended database modeling systems and more particularly relates to a distributed, open-ended, shared, data modeling system and method for heterogeneous datasets.

2. Related Art

Today's software systems for data compilation and management are predominantly based upon formalizing narrow information domains in order to store and access specific sets of data via a relational database server. While such systems are successful in that a working “computerization” of some useful set of information and processes has been achieved, they suffer from two particularly severe problems: (1) they are slow to adapt to changing requirements; and (2) they are incompatible across information domains. Both of these problems are caused by the direct dependence of the system on predefined database schemas.

Additionally any conventional database schema can be used to build multiple databases that are then allowed to operate more, or less, independently. Since they share a common schema, the data is theoretically compatible in some way. Some existing systems make use of such a network of databases, using various techniques for replication or merging of data. These types of systems are closed in that they merely provide distributed access for data encoded in the particular information domain specific schemas. Further, their replication and merging processes necessarily require certain and domain-specific rules. Therefore, what is needed is a system and method that overcomes these significant problems found in the conventional systems as described above.

### SUMMARY

Accordingly, systems and methods are provided that allow the information needed by any system to be computerized in a generic manner. While every system has requirements that are specific to the particular system, the systems and methods described herein allow information system designers to avoid commingling these specific requirements with the basic model for information. The systems and methods described herein provide an approach that allows information to be maintained without the need for the direct use of a relational database to encode information.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating an example network architecture according to an embodiment of the present invention;

FIG. 2 is a block diagram illustrating an example server according to an embodiment of the present invention;

FIG. 3 is a block diagram illustrating an example application server according to an embodiment of the present invention;

FIG. 4 is a block diagram illustrating an example database server according to an embodiment of the present invention;

FIG. 5 is a block diagram illustrating an example set of server architectural layers according to an embodiment of the present invention;

FIG. 6 is a block diagram illustrating an example set of client architectural layers according to an embodiment of the present invention;

FIG. 7 is a block diagram illustrating an example distributed database cluster according to an embodiment of the present invention;

FIG. 8 is a flow diagram illustrating an example temporal data model according to an embodiment of the present invention;

FIG. 9 is a flow diagram illustrating an example temporal data model according to an embodiment of the present invention; and

FIG. 10 is a block diagram illustrating an exemplary computer system as may be used in connection with various embodiments described herein.

### DETAILED DESCRIPTION

Disclosed herein is a system and method for implementing a data model in a distributed system. For example, one system as disclosed herein employs a plurality of servers in a cluster that collectively serve data in response to queries. Additionally, one method as disclosed herein allows for information to be stored in a distributed system according to a temporal data model that allows seamless integration of disparate datasets.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

In this description, the invention will be described in an embodiment of implementing a data model in a distributed system that includes distributed data storage and access, authoring techniques, querying techniques, access controls, and journaling, just to name a few of the components described in this embodiment. It should be clear that the data model may be implemented in alternative embodiments. Additionally, the data model described in this embodiment may be referred to as a data model or alternatively as a “worldline.” Worldline is a coined word that conjures up the temporal nature of the data model and the vast scope of data available for modeling there under. In some instances, the term “worldline” may be used to describe a data element within a dataset that is organized according to the data model.

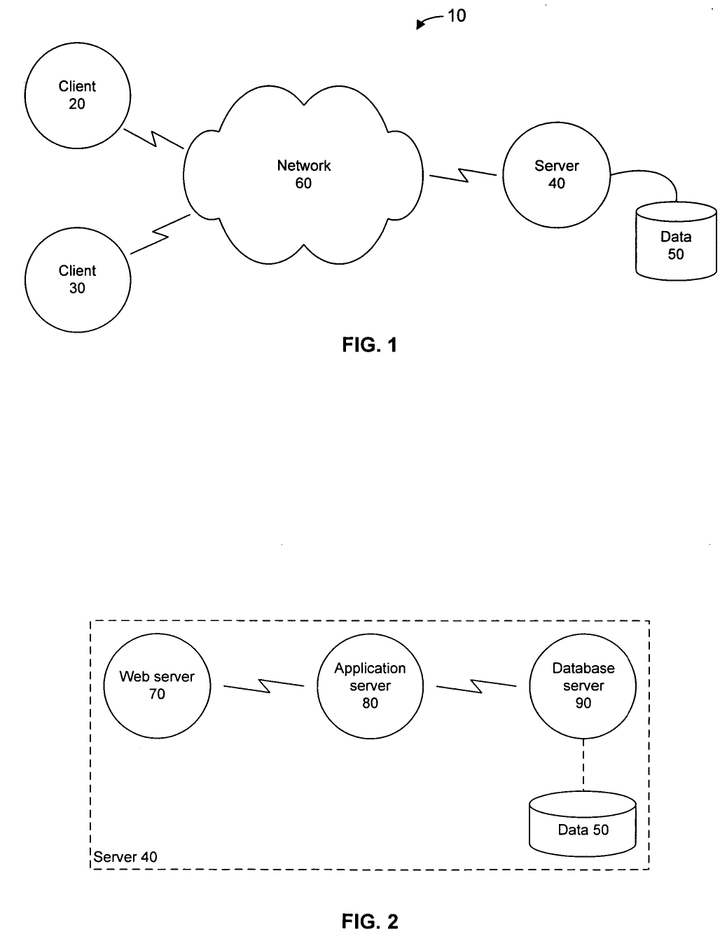

FIG. 1 is a network diagram illustrating an example network architecture 10 according to an embodiment of the present invention. In the illustrated embodiment, a plurality of clients 20 and 30 are communicatively coupled with a server 40 via a network 60. The server 40 has access to a data storage area 50. There may be any number of clients and the server 40 may be implemented as a single device or as a combination of multiple devices. The data storage area 50 may be integral to the server 40 or it may be a separate device.

A client such as client 20 may be any sort of access device, including a personal computer, a personal digital assistant, a laptop, cell phone, or other type of device with the ability to execute software and access network 60. The network 60 may be a wired or wireless network, it may be a public or private network, it may be a personal area network, a local area network, a wide area network, or a combination of networks such as the combination ubiquitously known as the Internet. Implementation of a networked client and server environment may take many alternative forms as well and all such embodiments are contemplated as falling within the scope of the present invention.

FIG. 2 is a block diagram illustrating an example server 40 according to an embodiment of the present invention. In the illustrated embodiment, the server comprises a web server 70, an application server 80, a database server 90 and a data storage area 50. As described above the data storage area 50 may be integral to the server 40 or it may be a separate device. The server 40 may be a single integrated unit or the illustrated components may themselves be separate units that collectively comprise the server 40. The function of the web server 70 is to handle network traffic that conforms to the HTTP protocol and provide access to the application server. The web server 70 may also be utilized to handle network traffic conforming to alternative communication protocols. The function of the application server 80 is to execute certain applications that allow for the implementation of a distributed data modeling system. The function of the database server 90 is to retrieve information from and save information to the data storage area 50. The application server 80 translates user actions into requests to the database server to retrieve and store information according the data model.

To achieve scalability of the server 40, the system may be implemented with various components combined into a single device or separated out onto dedicated devices to optimize performance and scalability. In one embodiment, the temporal data model may cause significant growth in the dataset or datasets being modeled because the fundamental structure of the data model efficiently incorporates related and unrelated information. Alternatively, the temporal data model also serves to reduce the size of the dataset or datasets because the fundamental structure of the data model efficiently identifies and eliminates redundancies among disparate datasets.

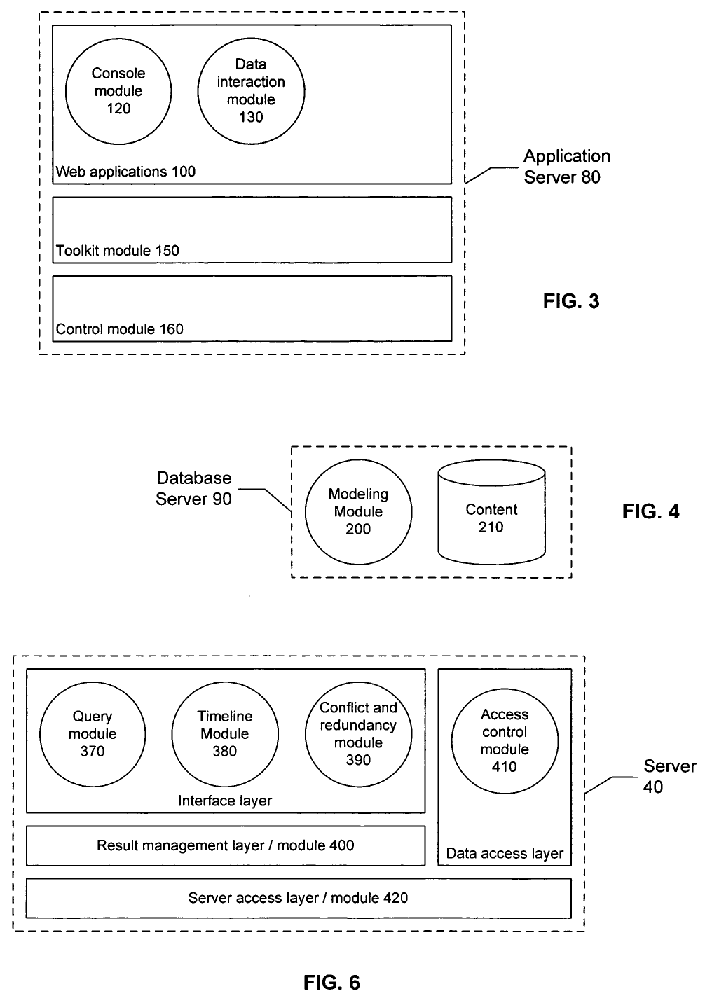

FIG. 3 is a block diagram illustrating an example application server 80 according to an embodiment of the present invention. In the illustrated embodiment, the application server 80 comprises web applications 100, a code library or “toolkit” module 150, and a control module 160. In one embodiment, the web applications may include a console module 120 and a data interaction module 130. The console module 120 is configured to provide administrative functions such as foreign data conversion and loading, and server test, backup and restore. The data interaction module 130 is configured to provide a full-featured session-based user experience that includes browsing, authoring, and reporting.

Also in the illustrated embodiment, the toolkit module 150 is configured to support the console and data interaction modules—and to do so by providing an application programming interface (“API”) to the server suitable to allow alternative console or data interaction modules to be developed by third parties.

The control module 160 is configured to perform as the main “engine” that gives the server its ability to perform transactions and queries on the data according to the data model. In the illustrated embodiment, the control module uses enterprise java beans to facilitate create, read, update, and delete (“CRUD”) of the content stored in the database server.

FIG. 4 is a block diagram illustrating an example database server 90 according to an embodiment of the present invention. In the illustrated embodiment, the database server 90 comprises a modeling module 200 and a content module 210. The modeling module 200 is configured to store commonly used data elements that may be shared across a wide range of applications. The content module is configured to store application-specific information.

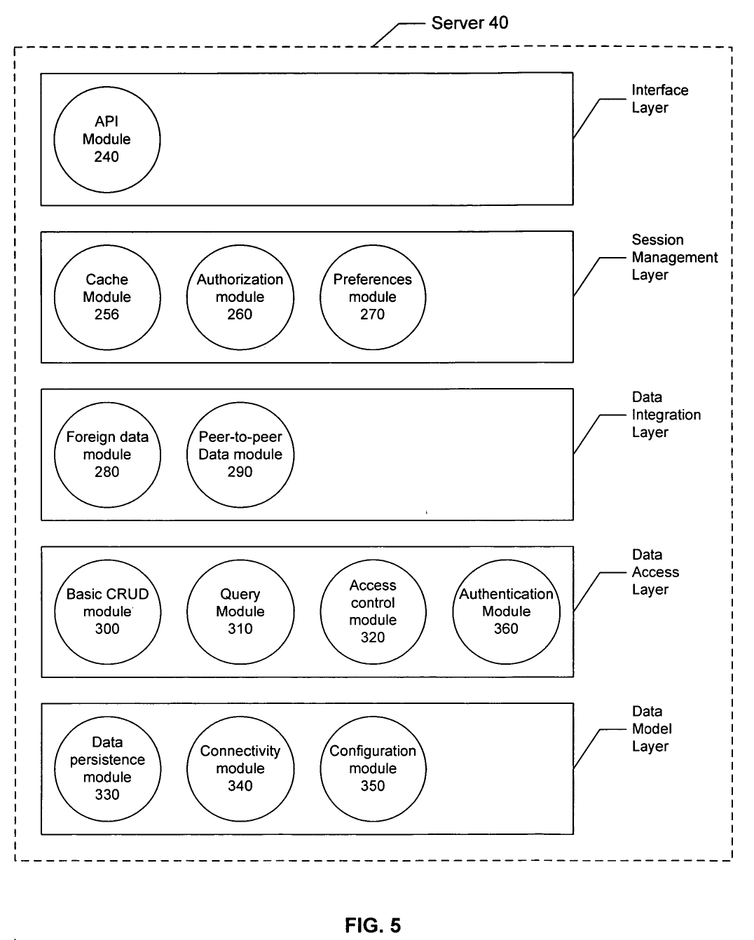

FIG. 5 is a block diagram illustrating an example set of architectural layers for a server 40 according to an embodiment of the present invention. This is an expanded view of the modules depicted in FIG. 3. In the illustrated embodiment, the architectural layers include an interface layer, a session management layer, a data integration layer, a data access layer, and a data model layer, each containing various modules. In alternative embodiments, there may be more or fewer layers as will be understood by one having skill in the art. The layers and modules represent a way of organizing the various functional components which would likely be needed to provide robust, scalable access and control for datasets organized according to the worldline data model.

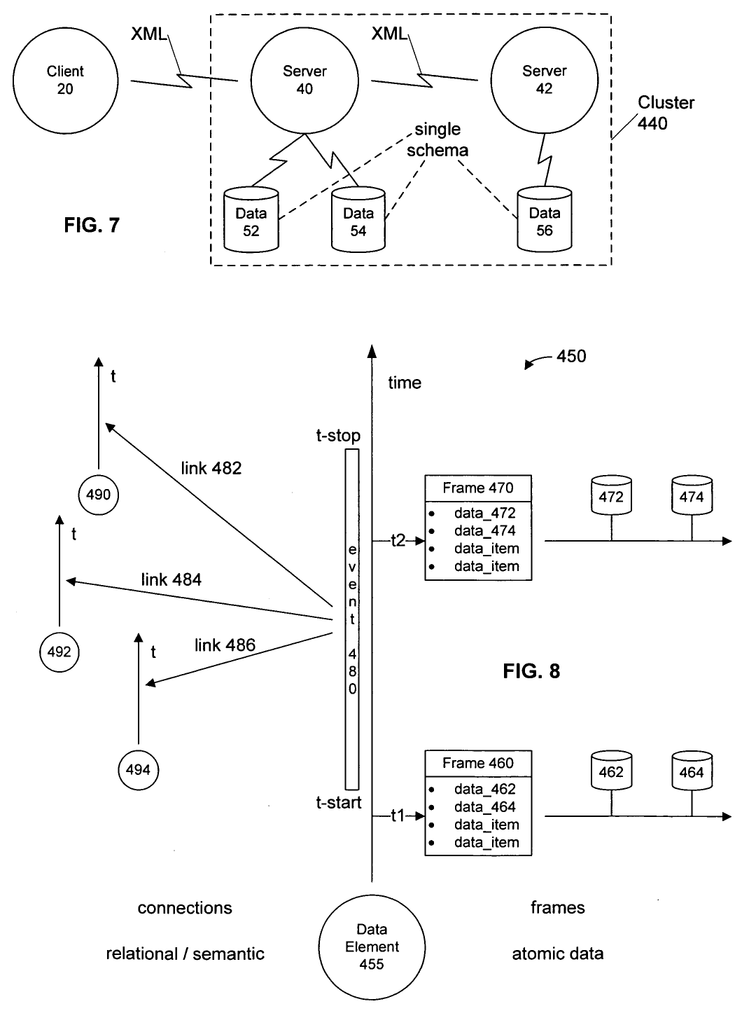

For example, granular access control may be implemented by using varying levels of sophisticated data access rights that can be assigned to a dataset or portions of a dataset. In one embodiment, a dataset can be divided up into various portions by implementation of a uniform resource identifier (“URI”). URIs are explained in more detail below with respect to FIG. 7. In such an embodiment, the various components of the URI can be targeted with different levels of access rights so that, for example, general data is openly accessible and specific data is more restricted.

Additionally, in one embodiment patterns within sets of URIs can be defined to indicate arbitrarily broad or specific groups of data. For example */com.incisix.*/core.medical/* may refer to all data elements created within any division of incisix.com in the core.medical project domain. Permissions on a dataset or portion of a dataset may be simple and include NONE, READ_ONLY, and READ_WRITE. Advantageously, permissions specific to the data model itself can be identified and put into practice. Additional permissions may also include CAN_READ_FRAMES, CAN_DELETE_EVENTS, CAN_CREATE_ALIASES, CAN_CHANGE_TIME, CAN_ADD_EVENTS, and CAN_CHANGE_FRAME_DATA, just to name a few. Thus, a traditional users and groups approach to permissions can be applied to datasets or portions of datasets. Furthermore, URI patterns can be assembled into groups and access permissions can be assigned to those groups.

In the illustrated embodiment, the interface layer includes an API module 240. The API module 240 preferably allows front end clients to be created for various access devices so that users of those access devices may communicate with the server 40. In one embodiment, the API module 240 is available via any market significant transport mechanism or network medium and any platform of client is capable of communicating with the server 40 via the API module 240, allowing the server 40 to support cross platform client devices.

In one embodiment, the API may itself employ a layered architecture so that modular development, security, and feature enablement may be implemented. For example, a basic CRUD API may be more desirable than an API that provides a client with control over the server's 40 peer-to-peer behavior.

The API also preferably supports querying so that a client can retrieve information and reconstitute that information in a meaningful way. The data model enables very granular organization of a dataset and the query capability in the API preferably extends that granularity to one or more clients through a rich query capability.

Also in the illustrated embodiment, the session management layer comprises modules that allow the server 40 to manage client sessions, including a cache module 256, an authorization module 260, and a preferences module 270.

In one embodiment, the session layer provides data source mediation that allows the server to manage real time access to one or more existing data sources such as relational databases or the like. For example, the real time access could be limited to read only access.

The cache module 256 in the illustrated embodiment is configured to minimize calls to the primary backing store. Additionally, the authorization module 260 is configured to enforce session-level privileges. The preferences module 270 in the illustrated embodiment is configured to allow individual users to enable or disable optional behaviors. Additionally, the data integration layer in the illustrated embodiment comprises a foreign data module 280 and a peer-to-peer data module 290. The foreign data module 280 is configured to interface with external data sources such as conventional relational databases, web services, flat files, proprietary systems with public API's, etc.

The peer-to-peer module 290 is configured to access information maintained in data storage areas that are not under the direct query control of a particular server. Accordingly, the peer-to-peer module 290 allows a server to communicate with other servers to provide transparent client access to a plurality of servers 40, perhaps arranged in a server cluster or even widely distributed. Advantageously, the fundamental nature of the data model eliminates any need for servers 40 to perform complex data manipulations or reformatting of data from a peer server.

In the illustrated embodiment, the data access layer comprises a basic CRUD module 300, a query module 310, an access control module 320, and an authentication module 360. The basic CRUD module 300 provides the ability to create, read, update, and delete data in the dataset. The query module 310 is configured to work with the API module 240 and preferably supports a rich querying capability so that a client can retrieve granular information organized by the data model and reconstitute that information in a meaningful way. The access control module 320 supports flexible, extensible enforcement policies, as will be understood by one having skill in the art.

Also in the illustrated embodiment, the data model layer comprises a data persistence module 330, a connectivity module 340, and a configuration module 350. The data persistence module 330 is configured to perform the actual transactions required to store and retrieve data from a backing store, such as a relational database. The connectivity module 340 is configured to perform protocol-specific functions required to communicate with other servers, such as making simple object access protocol (“SOAP”) requests for data. The configuration module 350 is configured to support a range of deployment-specific policies and settings, such as cache sizes, session timeouts, etc.

FIG. 6 is a block diagram illustrating an example set of client architectural layers according to an embodiment of the present invention. In the illustrated embodiment, the layers include an interface layer, a result management layer, a data access layer, and a server access layer. The interface layer comprises a query module 370, a timeline module 380, and a conflict and redundancy module 390. These layers can be implemented at the server (directly on top of the server layers), or within a managed deployment (for better load-balancing), or they can be implemented completely separately as a “thick” client.

The query module 370 is configured to allow for merging of data that is responsive to multiple queries from one or more servers. For example, a client may transparently send queries to three different servers and receive responses from those three servers that were retrieved from three discrete and separate data storage areas. Due to the fundamental nature of the data model, the responsive data received by the client will have a common format and the query module can merge the data from the three separate servers into a single client side view of the combined data.

In one embodiment, data from conventional relational databases and other types of databases can be intentionally transferred to a dataset that is arranged according to the worldline data model. Such data migration may be automated, through a query engine or through a specific migration effort. The timeline module 380 is configured to provide core support for visualizing the data over time, through the use of calendars, timelines, “swim lanes” and other conventional mechanisms.

The conflict and redundancy module 390 is configured to provide a means of discovering and resolving data conflicts in an appropriate way. This is similar to the “difference” and “merge” functions utilized in revision control systems, but in this case applies to elements of the worldline data model.

FIG. 7 is a block diagram illustrating an example distributed database cluster 440 according to an embodiment of the present invention. In the illustrated embodiment, a client 20 is communicatively coupled with the cluster 440 and the client 20 is configured to send and receive XML communications to the cluster 440 via a network or direct communication path. The cluster 440 comprises servers 40 and 42 that are configured to send and receive XML communications between each other. Additionally, there may be a plurality of clients. Each of the servers in the cluster may be configured to access one or more data storage areas 52, 54, and 56. The servers in the cluster 440 may be physical co-located or they may be geographically remote.

In one embodiment, it is the worldline data model itself that is represented as a schema in a relevant software modeling language. For example, a single SQL schema can be used to define a storage model for a dataset, and a single XML schema can be used to describe arbitrary subsets of that dataset. The software system provides basic create, read, update, and delete operations on the dataset and can be used as a foundation for custom applications.

In one embodiment, every data element in a dataset organized according to the data model possesses a unique resource identifier (“URI”). Thus, every element can be unambiguously addressed by a client without the need for any other contextual information. Advantageously, this enables several features of a dataset arranged according to the worldline data model, including: (1) the ability to be distributed across multiple data storage areas; and (2) the ability to define access privileges with extreme precision.

Advantageously, a URI can be used as a virtual primary key for a dataset. In one embodiment, every element of the data model is given a globally unique identifier. Alternatively, combining a URI with a uniqueness criterion provides an identifier that can facilitate multiple server operations, access control, and project management. For example, the form of a URI can be:
[element tag]/[organization tag]/[domain tag]/[element tag]

In this example, the element tag identifies the URI as referring to a particular type of element from the model, for example a DATA_ELEMENT or a FRAME. Additionally, the organization tag identifies the URI as originating with a particular organization, for example “com.incisix.sandiego”. The domain tag is a scoping mechanism that allows authors within a given organization to divide their URIs into logical groupings they deem appropriate. For example “core.engineering.models”, “users.jsmith.bookproject.events”. This ability to logically group the URIs facilitates successful access control. Finally, the element tag is the last piece of the URI and may be whatever is necessary to make the URI unique. Given that the URI is already scoped to a particular organization and domain (and element type), a meaningful, human-readable tag that also meets the uniqueness requirement is quite feasible, for example, “phone_list”.

Note this URI is not necessarily a primary key from the point of view of the underlying database implementation. It is a “virtual” primary key, from the point of view of the distributed system. An advantage of employing URIs is that conflict resolution and data merging can be achieved by creating equivalence mappings among URIs. When a set of conflicts has been resolved, any redundant URIs can be scheduled for removal from the system.

In one embodiment, the data model supports the notion of declaring two URIs to be equivalent. This allows the creation of alias URIs and, more importantly, the ability to merge the contents of multiple servers in meaningful ways.

In one embodiment, the data model can be adapted for programmatic use via an XML schema. This schema can serve as both a data transport mechanism and as an extensible query mechanism. The principle element of such an example schema is a fragment. A fragment is the container for XML representations of worldlines and event models (described in detail below), which in turn are composed of sub-elements that ultimately make up the complete data model. In one embodiment, a client fills in part of a fragment to form a query. Another appropriately filled in fragment represents a response to that query. The data transport structure and the query mechanism don't necessarily need to be implemented via the same XML schema. In one embodiment, this is how it is implemented.

Furthermore, the data model is adaptable for storage of the dataset in a relational database using an SQL Schema. Advantageously, this access layer may employ best practice SQL querying and indexing techniques, including vendor specific optimizations.

When the worldline schema is deployed across multiple servers there are a plurality of ways to partition the data, all of which are equally compatible. Partitioning choices can be based on any combination of data ownership, scalability or performance criteria, and any sort of topology can be achieved, from pure hierarchical to pure peer-to-peer and everything in between.

The use of an XML schema to represent fragments of a dataset to be transferred to and from the back-end data storage area provides a method for managing collaborative authoring and deployment efforts. A conventional database (or even an ordinary file system) can be used to store and organize such data fragments on behalf of multiple authors or workgroups. Proven techniques for managing dependencies among software modules (as in C++ include files or Java imports) can be used to manage these fragments of datasets. URI creation and management can be handled at this level as well. These standalone datasets can then be merged in specific combinations and with specific access permissions into one or more servers in a cluster or into a standalone server to facilitate different application purposes.

Another unique benefit of the single-schema data model approach arises when the worldline data model is also used in an audit trail or journaling mechanism associated with a given server. In this case, the data elements representing the players in an audit trail (e.g., the users, servers, software, groups, projects, etc.) can be linked effortlessly to correlate rich data about those players residing on other servers, since data in each worldline data model is uniformly compatible. Thus, decisions about how sophisticated to make the audit trail are simplified, while in conventional systems implementors must choose between building a custom audit trail solution or purchasing a limited one.

Additionally, the worldline audit trail capability, combined with the XML transport mechanism, combined with the ability to specify sets of URI patterns, enables unlimited server synchronization and propagation of data from server to server. Accordingly, an XML-based backup of all worldlines, connections, and frames that conform to a specific URI pattern can be used to extract a subset of data from one server in order to populate another server (even one running as a “personal server” on someone's laptop). After that, because EDITS to the data are themselves captured in the audit trail as (short-lived) worldlines, that second server can stay synchronized to changes it cares about on the first server by asking for the audit trail data and replaying it locally (e.g., performing all of the CRUD steps in the audit trail) to recreate any changes.

Furthermore, a more user-friendly query language is made possible because of the single-schema model. For example, even the most complicated type of query can be built out of intermediate results comprising worldlines, connections, or frames. A user interface may be provided that allows the user to modify the overall query by making choices that substitute for any of the intermediate results. For example, a query that produces a list of lab test results for subjects in a clinical trial may, by default, include all subjects and include test results for two dozen different tests. However, the query can be constructed so that the choice of subjects, and the choice of tests, each come from a separate sub-query that returns a list of worldlines for subjects and a list of worldlines for types of tests. Any user interface capable of displaying the components of the worldline data model could display these lists to the user and allow them to choose just a subset of subjects or test types. Further, the interface could allow the user to limit the set of subjects based on other connections or frames associated with those worldlines. For example, only subjects with a connection to a particular medical condition, or with height and weight frame values in a certain range.

FIG. 8 is a flow diagram illustrating an example temporal data model 450 according to an embodiment of the present invention. In the data model 450, the data element is the fundamental component that provides the data model with its organizational structure. A data element can be any type of entity that is capable of description in a temporal sense, for example, along a time axis. The data element 455 can also be referred to as a worldline. In the illustrated embodiment, the data element 455 comprises a plurality of events (although only a single event 480 is shown) and a plurality of frames. This dichotomy illustrates the division of a data element 455 into relational components and atomic data components. The relational components are represented by connections and the atomic data components are represented by frames.

Frames 460 and 470 each have a plurality of data items such as data items 462 and 464 in frame 46 and data items 472 and 474 in frame 470. These data items may be stored in a data storage area and represent the quantitative and physical or digital data that is associated with the particular data element 455. Each frame is also oriented along a time axis for the data element 455. For example, frame 460 and its data elements are associated with data element 455 at time t1. Similarly, frame 470 and its data elements are associated with data element 455 at time t2. Additional frames at different locations on the time axis may also be associated with the data element 455 to provide a rich set of quantitative and atomic data for data element 455 at various times along the time axis. These frames therefore provide the data model 450 with its ability to represent qualitative and quantitative information about a data element at a particular point along the time axis, thereby providing an atomic data aspect to the data model.

On the other side of the illustration of the data element 455 are a plurality of events. An event is defined by an event model (not shown). A single event 480 is shown for simplification of description, although a plurality of events can be associated with the data element 455. The event 480 has a start time and a stop time that defines the particular event. As will be understood, depending on the nature of the event the start times and stop times may be optional in that they may be coextensive with the existence of the data element on time axis. For example, in the case of a person, the “life” event would have the same start time as the data element itself and would also have the same stop time as the data element itself.

In the illustrated embodiment, the event 480 also has a plurality of links 482, 484, and 486. A link is defined by a link model (not shown). These links relate the data element (through the event 480) to other data elements 490, 492, and 494. Accordingly, a connection links two worldlines and comprises an event (with its associated start and stop times), a link, and a direction. These connections provide the data model 450 with its ability to logically join data elements to each other, thereby providing a relational aspect to the data model.

A more detailed description of one embodiment of frames, connections, link models, events, and event models is provided below.

Frames

Frames are used to capture any physical or quantitative aspect of a Worldline. This is where the atomic data is maintained. Advantageously, the atomic data is associated with the data element according to the temporal nature of the data. In one embodiment all frame data is represented uniformly as typed data (or pointers to data) that is considered to represent the worldline in some specific quantitative or qualitative way at a given point in time. For example, a JPEG image, longitude, latitude, annual salary: $52K, blood pressure: 80/120, and color: sky blue. Advantageously, such data may include a unit of measure such as annual salary, blood pressure, and color to provide context for the information and to enable comparisons of atomic data in conflict resolution or merging procedures.

The time associated with a frame places the frame at a particular point along the worldline for some duration (small or large). Additionally, there may be some uncertainty for the particular point in time and thus the frame may have a time range rather than a specific point in time. In the illustrated embodiment, t1 may be a particular day, which has a 24 hour range, for example. The data model can employ some type of dating mechanism here to gauge the appropriate range according to the uncertainty of the time. In one embodiment the time t1 may be comprises a start time, an end time, a start time uncertainty, and an end time uncertainty.

Although a frame can be conceptualized as a container for atomic data, it may also be a worldline itself. For example, certain types of data such as height, weight, home phone number, and driver's license picture, can be represented as independent data elements through time and are therefore capable of representation as separate worldlines while at the same time representing atomic data that is associated with a specific data element. Accordingly, a frame may be assigned a frame type to identify a frame as an independent worldline or as a container for data.

Similarly, as with frame types, the units of measure associated with the atomic data may also be represented as independent data elements. For example, the metric meter can be an independent worldline that includes information about the meter, it's adoption for use by various countries, its precise length at various points in time, why the length changed, and other interesting facts and connections for the metric meter.

In one embodiment, the frame values for a particular frame type and frame unit are all stored as the same type of value. For example, a frame type of Gross Annual Salary with the frame unit of US Dollars could store the frame value of 57,548.38. Thus, all such frame values would be stored as a double-integer, for example, so that all frame values sharing the same frame unit and frame type can be easily sorted or otherwise compared.

Frames may also have a frame text similar to the frame value. For example, a frame my have a frame unit of plain text, URL, XML, or other agreed-upon or well known text formats. For example one frame may have a frame type of “last words,” a frame unit of “plain text,” and a frame text of “rosebud.” Similarly, one frame may have a frame type of “last words,” a frame unit of “URL,” and a frame text of “<http://www.famoussoundbites.com/citizenkane/rosebud.mp3>.” Alternatively, the same frame may have a frame type of “last words,” a frame unit of “MP3” and a frame value that is the actual mp3 encoded binary file. Note that a frame may have either a frame text or a frame value or both.

Additionally, a frame may also have a frame source, which represents the source of the data in the frame. In one embodiment, when a frame is itself a worldline, then the frame source can point to that worldline so that additional information about the source of the frame data is available. For example, an image file used to provide frame image data for an individual may be a cropped version of a group photograph that is a worldline in its own right with links to the photographer, all of the photo subjects, etc.

With respect to the frame source, it may be advantageous to capture more clearly how a frame relates to its source worldline. In the example above, there may be a JPEG image for the entire photograph. Because it may be useful to know the exact region that was cropped from the group photograph, this data may be included in the frame. Thus while the frame source data may allow one to jump directly to the worldline for the complete photograph, the region data may allow one viewing the complete photograph to jump directly to the worldline for any individual in the photograph.

A frame may also provide a spatial representation for a worldline. In one embodiment, a frame can include data that quantifies a worldline's position, extension, and orientation in each of the dimensions of a given three dimensional coordinate system. Additional frames could be added as needed to describe the worldline's growth or motion over time and with the inherent time component of a frame, a four dimensional representation for a worldline is also provided. For example, a frame that described the basic shape of the worldline (e.g. sphere, cylinder, box, tube, torus, etc.) could provide better visualization, a texture-map frame still more sophistication, etc. Arbitrary groups of worldlines could thus be used to populate a map or other form of simulation at a given point in time or over a range in time.

One example of a frame can be described for a photographic image that is associated with the worldline for John F. Kennedy. In this example, we have the following: (a) frame type: photograph; (b) frame unit: URL; (c) frame text: <http://www.xyz.com/images/thumb/jfkathomejpg> (d) frame value: 134255 (bytes); (e) frame source: link to the worldline for the photograph “JFK at home”.

Additionally, the worldline for the photograph may have a frame associated with it that includes the following: (a) frame type: quantity purchased; (b) frame unit: integer; (c) frame value: 256,398; (d) frame source: link to the worldline for company X sales figures, line item 3.

The worldline for the Statue of Liberty may have frames that include, for example: (a) frame position-longitude: 100° W; (b) frame position-latitude: 48° N; (c) frame position-altitude: 10 m; (d) frame source: n/a; (e) frame height: 200 m; (f) frame major axis: 50 m; (g) frame minor axis: 40 m: (h) frame heading: 25° N/NW; (i) frame inclination: 90°; (j) frame rotation: 0°; (k) frame type: shape; (l) frame unit: VRML; (m) frame text: hollow cylinder; (n) frame value: n/a

Connections

In the illustrated embodiment, worldline 455 is shown as being linked to worldline 490 via link 480. Thus, the two worldlines are connected. A connection links the source worldline and the target worldline by way of a link that is described by a link model. Thus, a connection can be illustrated by: (source_worldline)→(link_model)→(target_worldline). A link model may itself be a data element capable of independent representation, and thus link models may be worldlines that are adaptable to perform the role of linking up two worldlines. For example, (eric_clapton)→(electric_guitar)→(layla).

In one embodiment, a connection includes three components to provide its context: (1) a link model, which is the reference to the target worldline that represents the relation between the linked worldlines; (2) the time period during which the connection is effective; and (3) the direction of the link to differentiate between the source worldline and the target worldline.

Wordlines that are connected inherently share a relationship of some kind. This relationship is described by the link model, which itself can be a worldline. For example, a link model may be a more general type of worldline that plays a certain role in the connection of the source and target worldliness. For example, the worldline for Major Tom and the worldline for Delta Airlines Flight 205 could be connected via the generic worldline for pilot.

The time period associated with a connection provides the temporal context for the link. This time period can be associated with the particular event from which the link extends. For example, when the worldline is for a professional baseball player, the event may be a specific baseball team. Thus, if the player played for the Chicago Cubs for 5 years, then any connections to other worldliness during the Chicago Cubs event may share the same start time and stop time. Alternatively, a connection may have a different start time and/or stop time, for example if the connection was to a spouse to whom the baseball player was married before joining the Chicago Cubs and after leaving the Chicago Cubs. In one embodiment, an events may provide a time period over which a connection has a specific interpretation.

In one embodiment, the direction of the link may be used to provide a hierarchical relationship to a connection. Advantageously, over the entire dataset, this hierarchical relationship may provide a sense of order for what could otherwise be a chaotic mass of connections. In some instances, a link model may seem to be too abstract to be an independent worldline. However, such concepts are likely to have a historical existence that is capable of representation upon a temporal axis. Thus, such concepts are also amenable to representation as an independent data element according to the data model.

In order to provide the directional context to a link, the two connected worldlines need to be distinguished from each other in a consistent manner that allows the connection to be properly interpreted when presented by software. In one embodiment, this can be achieved by identifying one of the worldlines the leftlink and the other worldline as the rightlink. For purposes of this description, the link model would be in between the two linked worldliness. For example, the link model “teacher” may be used to connect the worldline for Mrs. Miller and the worldline for West Ridge Elementary School is the rightlink. Alternatively, in another example, (i.e “West Ridge Elementary School [had a] teacher [named] Mrs. Miller”) the worldline for West Ridge Elementary School is the leftlink and the worldline for Mrs. Miller is the rightlink. Advantageously, the capability of the link to go in either direction enables maximum flexibility in the organization of the dataset without a rigid structure based on complex semantic rules.

An additional example uses the “father” link model to connect the worldliness for Homer and Bart. In this example (i.e., “Homer [is the] father [of] Bart”), the worldline for Homer is the leftlink and the worldline for Bart is the rightlink. This same connection may also be expressed through the “son” link model. Thus, in this example, (i.e., “Bart [is the] son [of] Homer”), the worldline for Bart is the leftlink and the worldline for Homer is the rightlink.

The leflink and rightlink concept may also be described as the uplink and downlink concept. Although specific left/right or up/down implementations are left to the implementers, many examples demonstrate that one of the connected worldliness is the primary while the other is the secondary. This relationship may be derived from the semantics of how the connection is described (such as “father” or “son”). In some instances, consideration of the worldliness being connected may eliminate confusion. For example, when modeling of marriage of two individuals, the link model “marriage” can be used. This link model provides no real distinction between the two worldlines being connected by the “marriage” link model and accordingly may be difficult to comprehend. On closer consideration, however, the link model “husband” or the link model “wife” can be used. In such a solution, the worldline for the man can be connected to the worldline for the marriage using the link model “husband” while the worldline for the woman can be connected to the worldline for the marriage using the link model “wife.” This might look like: (person X)→(wife)→(marriage_of X_and Y) and (person_Y)→(husband)→(marriage_of X_and₁₃ Y).

In one embodiment, there may be multiple connections between two worldlines. For example, the worldline for Grover Cleveland would have two connections to the worldline for President since the time period for his first presidential term is not consecutive with the time period for his second presidential term. Various alternative examples may also be described where multiple connections between two worldlines are present because some combination of the three parameters: (1) link model, (2) connection period, and (3) direction, are varied. Advantageously, the data model allows these multiple connections as they more closely represent real world data.

For example, a simple case of multiple connections is when two worldlines enter into a new relationship. For example, suppose there is a “customer” link model that links the worldline for person_P to a worldline for company_C. If person_P subsequently is employed by company_C, a new “employment” link model would then connect the worldline for person_P to the worldline for company_C. This would be a new and additional connection between the two worldlines. This is an example of different connection periods.

In another example of multiple connections, two worldlines may have multiple simultaneous connections. For example, the worldline for a musician might be linked to the worldline for a performance by the link models for both “guitarist” and “vocalist” with both connections running simultaneously. This is an example of different link models.

Another example of multiple connections may be a connection between the worldliness for Homer and Bart, with the first connection using the link model “father” and the second connection using the link model “son.” Although these multiple connections between two worldlines represent the same relationship from different perspectives, their existence as separate connections is valid because the properties of the link model “father” are different from the properties of the link model “son.” This is an example of different directions.

In one embodiment, resolution techniques may be employed to identify and possibly merge these types of same relationship connections, for example to minimize redundancy and optimize the storage of data.

It should be noted, however, that some instances of apparently redundant connections may represent a dispute about the connection between the two worldlines. For example, what might appear to be a simultaneous relationship might actually represent a dispute about the correct link model to use. Additionally, what might appear to be a repeated connection might actually represent a dispute about the correct start time, and what might appear to be a new relationship might actually represent a dispute about the correct link model and the correct start time. Additional multiplicities might actually represent disputes relating to the direction of the connection, and so on.

Event Models

Event models describe the types of connections that are associated with an event and also describe the types of frames associated with an event. Event models support the generality and abstractness allowed by link models (e.g., employment, birth, education). In one embodiment, an event model may define a set of link models that describe the kinds of connections that participate in an event. Thus, a connection can be seen as an atomic element that can be grouped with other connections that collectively participate in an arbitrarily complex group of connections that can be referred to as an event, such as the illustrate event 480 according to the embodiment shown in FIG. 8.

In one embodiment, an event model can be used to present the user with dynamically-generated data-input or data-display forms. For each connection type or frame type in the event model, the user can be presented with an appropriate edit field or drop-down list. When the user submits the form, a new event is created with all of the specified connections and frames. Different event model “overlays” can be used to provide different perspectives on the data, without changing the underlying structure of the data model.

For example, an event model is a named grouping of types of connections and types of frames. An event model may function as a template for an actual event that applies the grouping to the various connections and frames for a particular worldline over a particular period of time.

In one embodiment, an event model comprises class link(s), parent model(s), start/stop description(s), link model(s), frame type(s), override(s), and relational cardinal(s). For example, an event model may be considered to represent one or more classes of worldlines (e.g., people, airplanes, corporate mergers, etc.). These classes may themselves be worldlines as previously discussed. Additionally, event models can be organized into hierarchies which inherit the properties of their parent event model(s). Further context may also be given to the type of event providing a variable description of the start and stop times that bound an event being described according to the particular event model. Finally, a list of link models and associated constraints may be included to specify which connections can be included in an event being described according to the particular event model and also a list of frame types and associated constraints may be included to specify which connections can be included in an event being described according to the particular event model.

In one embodiment, link models and frame types in a child event model will typically extend the group of link models and frame types defined in its parent event model. If desired, however, a link model or frame type in a child event model may instead override or replace a specific link model or frame type defined by the parent event model. Overriding the constraints in addition or separately may also be permitted. Additionally, a frame type can have a cardinality that determines whether it can or should appear multiple times in a single event.

Furthermore, a more user-friendly query language is made possible by event models because an event model can be used to provide logical suggestions for the kinds of parameters to include in a query. For example, an employment event model could be used to suggest to the user that a query based on connections such as “employer” or frames such as “salary” would be appropriate.

Additionally, event models advantageously provide dynamic import assistance when importing data into a dataset. For example, the event model can be displayed to a user importing the data to provide the user with the ability to describe how to import foreign data.

Events

Events are individual instantiations of an event model. Events are the specific, time-bounded group of connections and frames for a worldline. A worldline may comprise multiple, possibly overlapping events that collectively capture varying levels of detail. For example, the education of an individual could be described as a long event spanning all of the years the individual was formally a student. Such an event would have connections and frames representing the various schools attended, courses taken, teachers, etc. Alternatively, the education of the individual could be described as a series of events, with each event covering the years that the individual was attending a particular educational institution. These various events would also have connections and frames representing the various courses taken, teachers, etc. In yet another alternative, the education of the individual could be described as a series of event, with each event covering each individual course taken. In this alternative, each event would have connections and frames representing the various educational institutions, teachers, etc. In still another alternative, each of the three above described alternatives could co-exist.

Advantageously, events are highly flexible and customizable. In one embodiment, an event can be described by its worldline, timespan, event model, and dynamic event connection. For example, an event is always associated with a particular worldline. In many cases, what may appear to be an event may not be an event but instead be a worldline. For example, a football game, which appears to be an event, can actually be a worldline, such as the worldline for Super Bowl XXXIV. Because Super Bowl XXXIV can be defined relative to multiple worldlines (each player, each team, each fan in attendance, the stadium, etc.), what appears to be an event is instead a worldline of its own. Thus, the event-like aspects of Super Bowl XXXIV can then be modeled—for example the scheduling of the game and the playing of the game.

In one embodiment, to provide an event with a timespan, some notion of a start time and an end time is needed. Preferably, an indication of the degree of certainty for the start and stop times is also provided.

Advantageously, in one embodiment after the worldline, timespan, and event model are declared for an event, various connections and frames may dynamically and automatically become part of that event. For example, a connection that has the event's worldline as either its rightlink or leftlink would be part of the event. A connection that uses a link model that is specified in the event's event model would be part of the event, and a connection that is in effect at during the timespan of the event would be part of the event.

In one embodiment, connections may be filtered so that only the connection with the most complete overlap with the timespan of the event is considered part of the event when two or more connections are related (such as the “father” and “son” connections described above).

In another embodiment, with respect to frames, once the worldline, timespan, and event model are declared for an event, frames that belong to the event's worldline may dynamically and automatically become part of that event. Additionally, frames that have a frame type that is specified in the event model for the event can also become part of the event and frames that exist at a time during the timespan of the event can become part of the event.

In one embodiment, frames may be filtered so that only the frame with the most complete overlap with the timespan of the event becomes part of the event when two or more frames exist that both at least partially overlap with the timespan of the event.

In addition to the dynamic assignment of various frames and connections to an event, frames and connections may also be explicitly identified with an event. For example, any connection may be identified as an explicit event connection. In one embodiment, if the link model for the connection is not present in the event model for the event, then a link model from the event model for the event can be selected to be the overriding link model. Alternative implementations may also choose to prohibit explicit event connections whose timespans do not actually overlap with the timespan for the event.

Similarly, any frame may also be chosen to be an explicit event frame. If the frame type for the particular frame is not present in the event model for the event, a frame type from the event model can be selected to be the overriding frame type. Alternative implementations may also choose to prohibit explicit event frames whose timespans do not actually overlap with the timespan for the event.

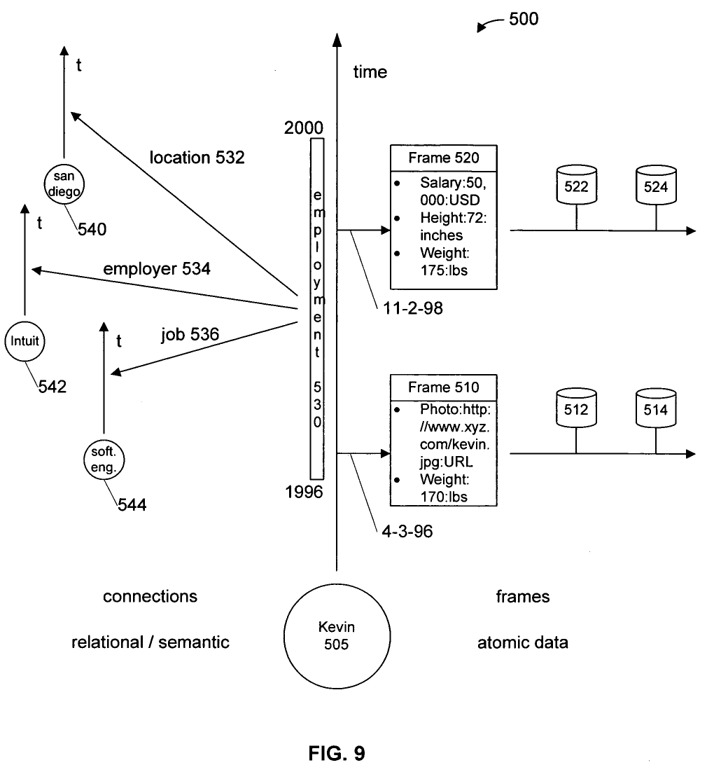

FIG. 9 is a flow diagram illustrating an example data model 500 according to an embodiment of the present invention. In the illustrated embodiment, a data element 505 is shown. The data element 505 is for an individual person named Kevin. The data element 505 comprises frame 510 and frame 520. Frame 510 is representative of atomic data on the date Apr. 3, 1996. The data included in frame 510 includes a photograph of Kevin and his weight on Apr. 3, 1996. Each data item included in the frame includes a description of the item, a quantitative value, and a unit of measure. For example, the data item for weight includes the descriptor “weight” the value “170” and the unit of measure “pounds” abbreviated in the figure as LBS. This quantitative and qualitative data is stored in one or more data storage areas such as data storage areas 512 and 514. Additional data representing a snapshot of information for the data element 505 as of Apr. 3, 1996 may also be stored in frame 510.

Similarly, frame 520 is representative of atomic data on the date Nov. 2, 1998. The data included in frame 510 includes Kevin's salary and Kevin's height and weight. These data items similarly have a descriptor, a value, and a unit of measure. Advantageously, providing a unit of measure for a data item facilitates the later comparison of data items or conversion of data items to enable accurate comparison. This quantitative and qualitative data is stored in one or more data storage areas such as data stnhorage areas 522 and 524. Additional data representing a snapshot of information for the data element 505 as of Nov. 2, 1998 may also be stored in frame 520.

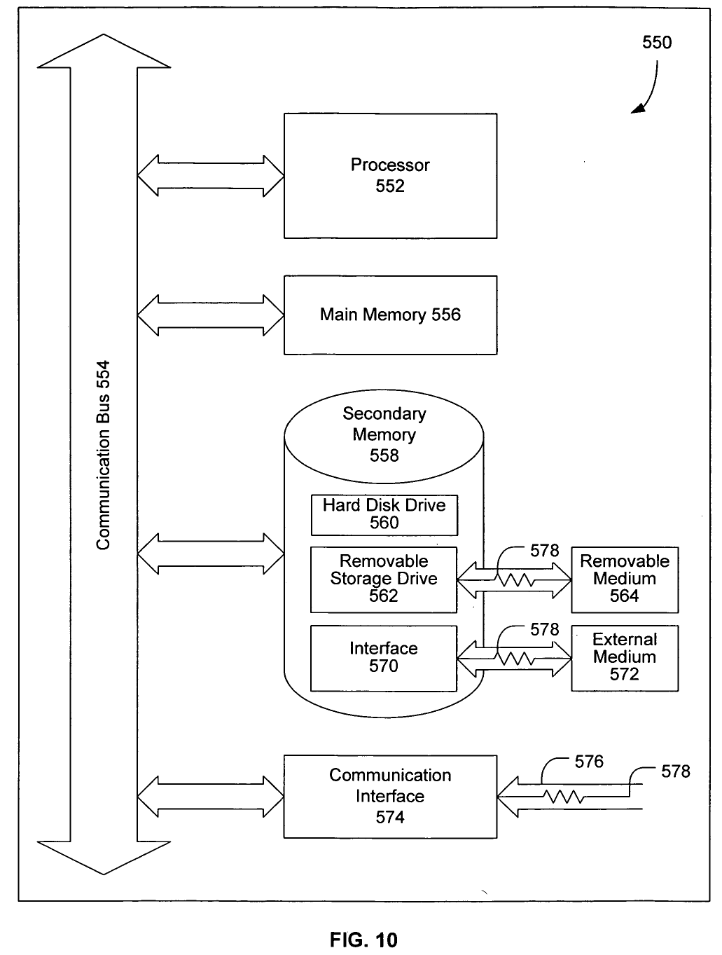

FIG. 10 is a block diagram illustrating an exemplary computer system 550 that may be used in connection with the various embodiments described herein. For example, the computer system 550 may be used in conjunction with various components identified in FIGS. 1 and 2 such as the client 20, server 40, web server 70, application server 80, and database server 90. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A single schema distributed database system, comprising:
a client module communicatively coupled with a network;
two or more server modules communicatively coupled with the client via the network, each server module communicatively coupled with a data storage area, wherein each data storage area comprises a dataset conforming to the same schema, comprising:
a plurality of data elements, each data element comprising a unique resource identifier (URI) and including a plurality of frames and a plurality of connections, wherein a frame is configured to store atomic data values; and wherein a connection is configured to relate a source data element to a target data element, the connection further comprising
an event having a start time and a stop time, the event conforming to an event model;
a link model configured to describe an association between the source data element and the target data element; and
a directional indicator configured to identify the source data element and the target data element.

2. The system of claim 1, wherein at least two server modules are located on separate networks.

3. The system of claim 1, wherein each of the two or more server modules comprises an audit trail conforming to the schema.

4. The system of claim 1, wherein each URI has an associated set of permissions and each of the two or more server modules comprises an access control module configured to control access to data in the dataset based on said URI permissions.

5. The system of claim 1, wherein the event model provides a format for importing foreign data into the dataset.

6. The system of claim 1, wherein the event model forms the basis for a dynamically generated a data interaction form.

7. The system of claim 6, wherein the data interaction form is a data entry form.

8. The system of claim 6, wherein the data interaction form is a data query form.

9. The system of claim 6, wherein the data interaction form is an import data form.

10. The system of claim 1, further comprising a query set, wherein the query set is predetermined according to the schema.
